(19) United States
(12) Patent Application Publication
(10) Pub. No.: US 2002/0181060 A1
(43) Pub. Date: Dec. 5, 2002

(54) Beamcast (continuous infrared data beaming system)

(76) Inventor: Chiang-Lung Huang, Bound Brook, NJ (US)

Correspondence Address: Royal W Craig, Law Offices of Royal W Craig, Suite 153, 10 North Calvert Street, Baltimore, MD, 21202, US

(21) Appl. No.: 10/148,715

(22) PCT Filed: Aug. 1, 2001
(86) PCT No.: PCT/IB01/01708

(51) Int. Cl. H04B 10/00

(52) U.S. Cl. 359/172; 359/152

(57) ABSTRACT

A Continuous Data Beaming System that is capable of continuously and automatically beaming data by direct transmission from one Host Device (source device or “beaming station”) to another Remote Device (receiver device) every time the receiver needs the data. The Host Device constantly searches to find an IrOBEX compliant Remote Device, checks availability for an infrared connection, completes the connection to the Remote Device and transfers a data object through the respective infrared ports. If a failure occurs during any of the foregoing steps, the program automatically returns to searching. This progresses in an infinite loop, thereby accomplishing continuous, wireless, infrared data transmission. During the continuous transmission, no Remote Device other than BeamMaster can interrupt the continuous beaming. The BeamMaster Device allows the system to halt for a brief period, thirty seconds or less, so that files or data objects may be swapped. Continuous beaming resumes once the files are swapped or the time has expired. The Host Device automatically transmits data to the receiver device every time a receiver shows up and needs the data, thereby effectively achieving one-touch wireless synchronization.

### TECHNICAL FIELD

1. Field of the Invention

The present invention relates to data interchange between computers and, more particularly, to a method for continuous, wireless, data transmission from one source device to another.

2. Background Art

Wireless communication is playing an increasingly important role in computer data interchange, particularly for users of mobile computers. This is because it is often necessary to transfer specific data while traveling, when there is no access to conventional telephone lines or other hard-wired means of data transfer. There are several media for wireless data communications. Infrared optical energy, based on the IrDA and IrOBEX protocols, is one well-known exemplary medium for wireless data communications. See, J. M. Kahn and J. R. Barry, “Wireless Infrared Communications”, Proc. of the IEEE, pp. 265-298, February 1997. (Invited Paper); J. M. Kahn, J. R. Barry, M. D. Audeh, J. B. Carruthers, W. J. Krause, and G. W. Marsh, “Non-Directed Infrared Links for High-Capacity Wireless LANs”, IEEE Pers. Commun. Mag., vol. 1, no. 2, pp. 12-25, Second Quarter 1994. Bluetooth wireless technology, based on Bluetooth Object Push Profile, is another exemplary medium. Bluetooth is an open standard for short-range wireless communication between devices over the publicly available radio spectrum, eliminating the need to employ connecting cables and to point to a device.

The preferred infrared communication requires a point-to-point or multipoint communication link via either fiber optic cable or direct free-space aimed transmission. Direct free-space transmissions require a substantially straight line path between a transmitter and receiver which is transparent to the communications media. An example of such a direct free space transmission is remote control of a television. The remote control unit must be aimed at the receiver of the television in order to activate any kind of control.

Direct free-space transmission links are becoming more common, and this is reflected by the fact that many computer hardware and peripheral makers now integrate infrared (“IR”) devices into their computers, printers, organizers, phones, watches, etc. Conventional application software that governs the infrared ports in such devices allows predefined data to be transmitted from a source to a compatible receiver through the IR ports of the two. This IR transmission application software is especially useful in the context of personal digital assistants (“PDA”s), which are generally designed for fast and efficient distribution of any information anywhere.

There have been a few known attempts to provide improved IR transmission application software. For example, U.S. Pat. No. 5,889,604 shows a method of and apparatus for infrared data communications between portable information terminals that purports to save battery power by evaluating the data bits to be transmitted and inverting them if the inverted bit stream would require less energy to transmit.

U.S. Pat. No. 4,977,618 shows a diffuse infrared data communications method for wireless communications of information between two locations. The infrared radiation is transmitted to a reflecting surface which redirects the beam to a receiver.

In addition, Extended Software® provides an IR management program called QuickBeam® for transferring file(s) between computers that allows portables to automatically detect and connect to each other. The program itself is simple and intuitive, it allows the transfer of files and folders with just a single instruction from the operator. The application enables transfer of a 1 Mb file in only 10 seconds, and it meets IrDA object exchange (OBEX) standards.

Unfortunately, these and like systems require an operator to initiate the transmission application software at both the transmitting end and the receiving end and, once done, to control the process from one of the two terminals. This is very inconvenient, especially when a fast data transfer between a PDA and host computer is desired.

It would be greatly advantageous to provide a Continuous Data Beaming System that is capable of continuously and automatically beaming data by direct wireless transmission from one source or host device (or “beaming station”) to another remote or receiver device every time the receiver needs the data.

It would also be advantageous to provide a Continuous Data Beaming System that is capable of being interrupted for a brief period of time to allow for swapping files or data objects, before resuming continuous data beaming.

### DISCLOSURE OF INVENTION

It is therefore, an object of the present invention to provide a Continuous Data Beaming System that is capable of continuously and automatically beaming data by direct transmission from one source or host device (or “beaming station”) to another remote or receiver device every time the receiver needs the data.

In accordance with the above-described object, the present invention provides a system and method for continuous data beaming from one source device to another receiver.

The source device, or beaming station, is configured through the continuous data beaming software application so that it automatically transmits data to the receiver device every time a receiver shows up and needs the data. It constantly searches for a remote target device if the data transfer is interrupted or finished, thereby it effectively achieves one-touch wireless synchronization.

The method begins with a Host Device, which checks the HotSync schedule to determine if it is time to HotSync to the server to update files and if the time equals the schedule time, HotSyncs to the server, updates the files. The Host Device searches to find an IrOBEX or Bluetooth Object Push Profile compliant Remote Device. If the Host Device cannot find an IrOBEX or Bluetooth compliant Remote Device, the program returns to searching. However, if the Host Device finds an IrOBEX or Bluetooth Object Push Profile compliant Remote Device, it checks availability for a connection. If the Remote Device is not available for connection, the program again returns to searching. If the Remote Device is available for connection, the Host Device completes the connection to the Remote Device and transfers a data object through the respective ports. If the data object is not transferred successfully, the program returns to searching. If the data object is transferred successfully, the event is recorded in a log file. The foregoing progresses in an infinite loop, and in this manner accomplishes continuous, wireless data transmission during which regular user Remote Devices cannot interrupt the continuous beaming.

It is another object of the present invention to provide a system to halt the continuous data beaming for a maximum of thirty seconds to replace a file or data object with a new one, before resuming the continuous beaming. This is accomplished by a Remote Device called BeamMaster equipped with BeamMaster software, used by an administrator only. This system is particularly convenient when the BeamCast device is in a locked and secured beaming kiosk because there is no need to physically open the kiosk to replace the beaming host device with a new file or object to beam. The BeamMaster software updates the data files or objects, e.g., daily updates for shows or events, remotely, with no visible interruptions, except for the minimal interruption when BeamMaster halts the system and updates the contents.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a conceptual diagram of the system according to the present invention.

FIG. 2 is a conceptual diagram of an IrDA transport stack

FIG. 3 is a flow-chart depiction illustrating the method steps of the present invention.

FIGS. 3.1 through 3.9 are exemplary source code of the method for continuous, wireless, infrared data transmission from a Host Device to a Remote Device, written in the “C” programming language.

### BEST MODE(S) FOR CARRYING OUT THE INVENTION

The preferred embodiment of the present invention is a method and software application of the method for continuous, wireless, infrared data transmission from a Host Device to a Remote Device. In the preferred embodiment both Host Device and Remote Device must be IrDA compliant to perform wireless communication. IrDA is an International Organization that creates and promotes interoperable, low cost infrared data interconnection standards that support a walk-up, point-to-point user model. The standards support a broad range of appliances, computing and communications devices. The present invention is hardware and platform independent, for example, data can be transmitted through the IR port or other computer systems and peripherals from the following platforms: Unix, Linux, Windows-based (including Windows CE), Embedded Systems, Palm handhelds, etc. It can also run on a custom-built device of any shape that has IR components controlled by a microprocessor. The data can be beamed to any of the following exemplary receiver devices: watches, cell phones, palm handhelds, etc. The application finds great utility with multiple purpose hand-held devices for fast data downloads and information distribution. One important characteristic of the present method is that the beaming capability is turned on all the time and thus the Host Device searches for a Remote Device continuously. This capability provides a simple and elegant way for festival and seminar attendees to find their way around the events and festivities without carrying around cumbersome paper guides.

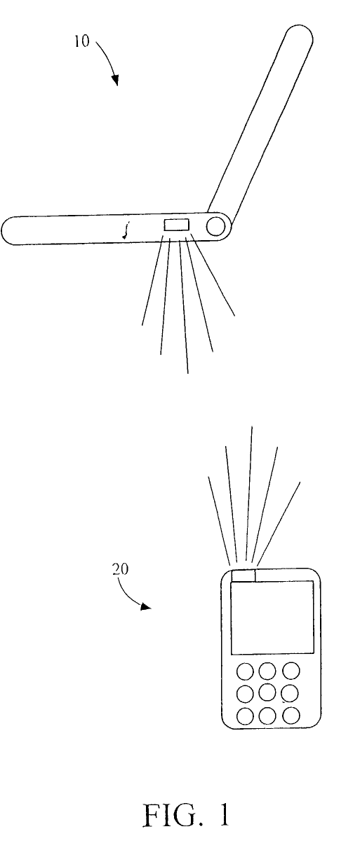

FIG. 1 is an exemplary conceptual diagram of the system according to the present invention. A laptop computer is the IrDA or IrOBEX compliant Host Device 10, and a personal digital assistant (PDA) is the IrDA or IrOBEX compliant Remote Device 20. Both are equipped with conventional infrared ports such as, for instance, IrDA compliant Agilent Semiconductor HSDL-2100 IR Transceivers.

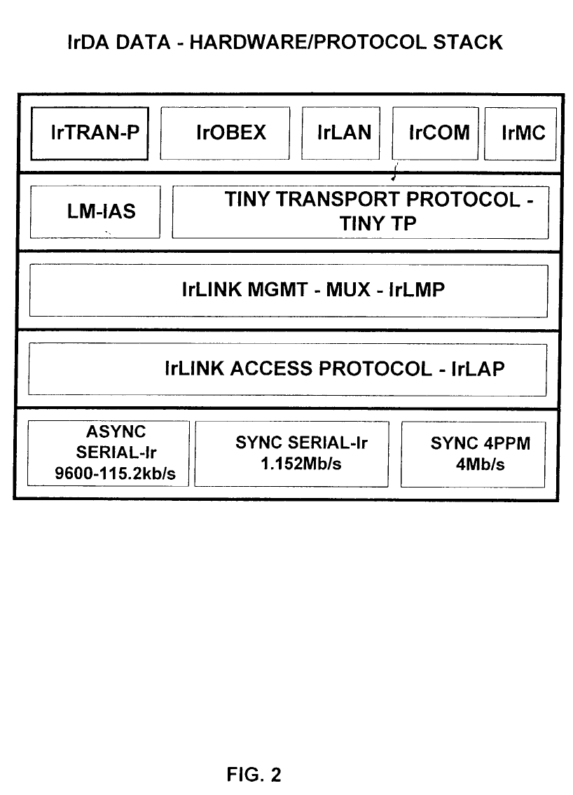

Both Host Device 10 and Remote Device 20 are also equipped with a standard IrDA transport stack and the optional IrOBEX Data Protocol. As seen in FIG. 2, the IrDA transport stack comprises a series of protocols arranged as a stack, where data from application programs are passed down through the stack and eventually transmitted as light pulses through the transceiver. The IrDA specifications provide guidelines for the following protocols: 1) link access (IrLAP); 2) link management (IrLMP); 3) Infrared Tiny Transportation Protocol (IrTTP); 4) and for the electrical-optical hardware interface (Physical Layer). A brief summary of these protocols follows:

1) IrLAP (Infrared Link Access Protocol) provides a flow-control mechanism between the physical data link layer to the upper layer. See, T. Williams et al., “Infrared Data Association Serial Infrared Link Access Protocol (IrLAP)”, Version 1.1, a joint technical paper submitted by IBM Corporation, Hewlett-Packard Company, Apple Computer, Inc., and Counterpoint Systems Foundry, Inc. to the Infrared Data Association, Jun. 16, 1996. IrLAP constitutes one layer in this hierarchical stack of communication protocol layers. It uses services provided by the physical layer and provides services to the layer above it—referred to as “The Upper Layer” and “The Service User (Layer)” IrLAP uses four service primitives (request, indication, response and confirm) to communicate with the upper layer in order to manage the communication processes on the IR link between devices.

2) IrLMP (Infrared Link Management Protocol), which supports walk-up, ad hoc connection between IrDA devices. By this protocol, one device can query the other to discover the services available on it. The protocol provides support for multiple software applications/entities to operate independently and concurrently, sharing the single link provided by the IrLAP between the primary device and each secondary device.

3) IrTTP (Infrared Tiny Transportation Protocol), which provides an independently flow-controlled transport connection, segmentation and reassembly.

4) The IrDA Physical Layer (Physical Layer) comprises the electrical-optical hardware interface, which in the present example might be an IrDA compliant Agilent Semiconductor HSDL-2100 IR Transceivers.

5) The IrOBEX protocol is an optional IrDA protocol and provides object exchange services similar to HTTP.

The foregoing protocols are exemplary of data transmission protocols upon which the Continuous Data Beaming method and application of the present invention may rely.

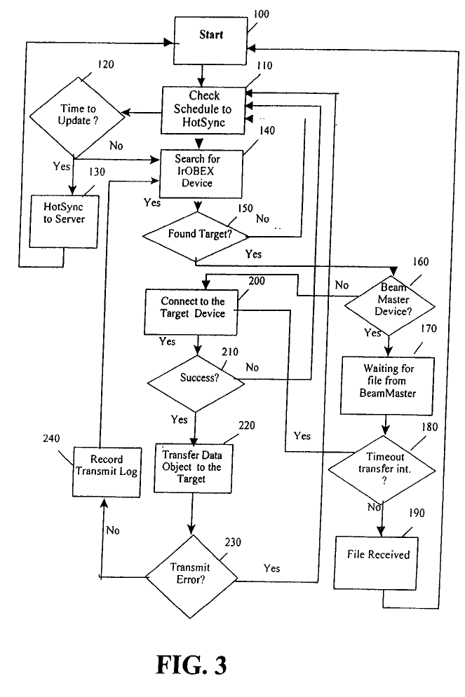

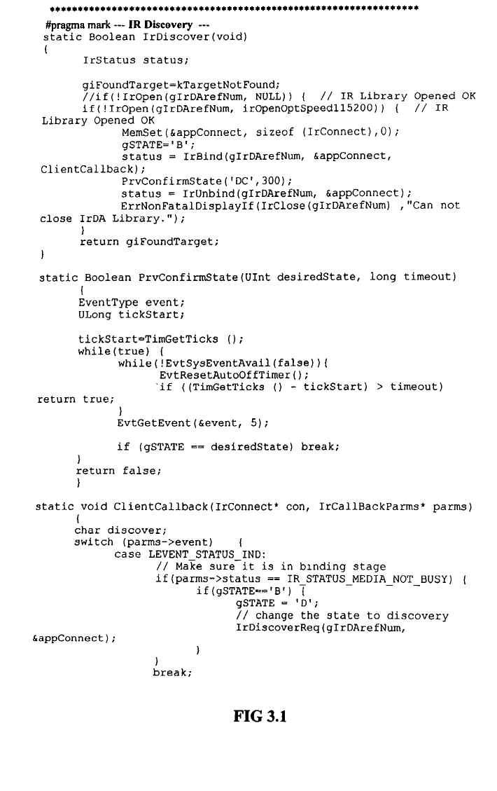

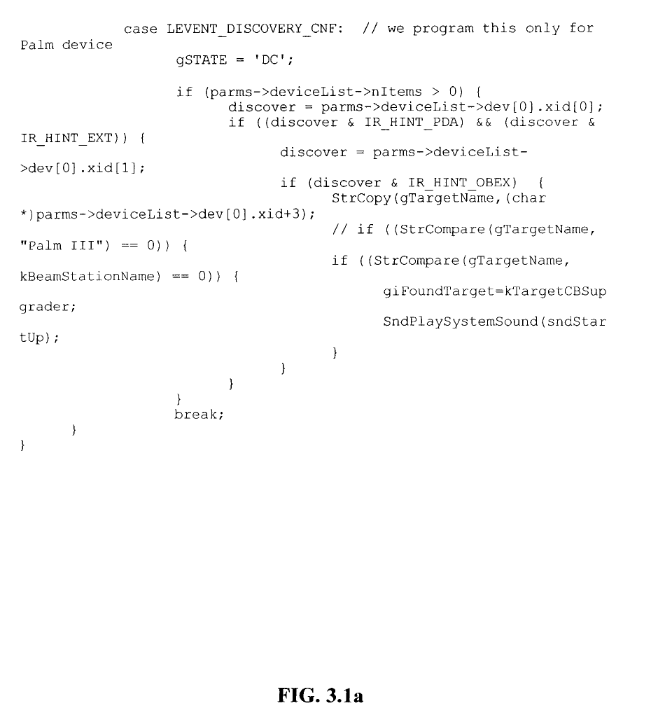

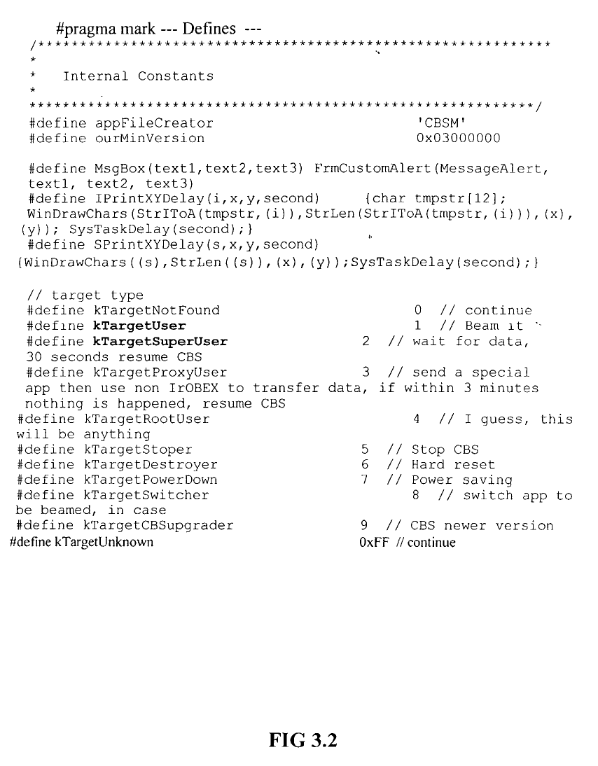

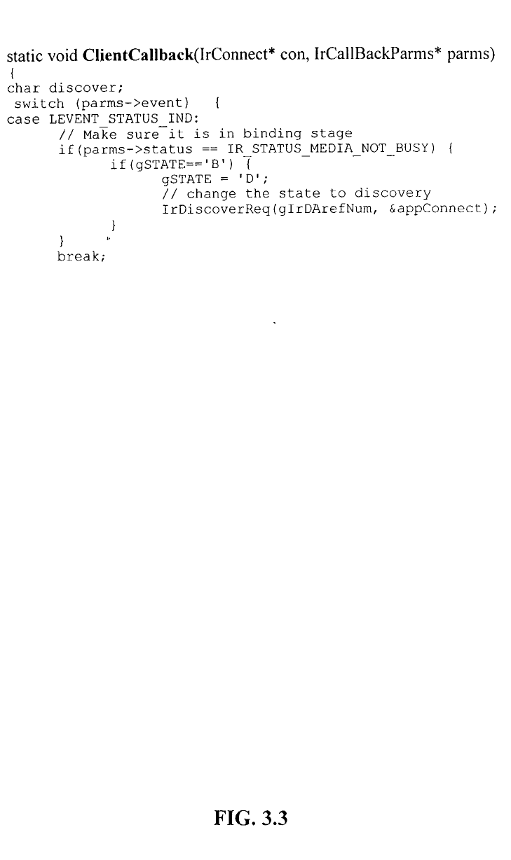

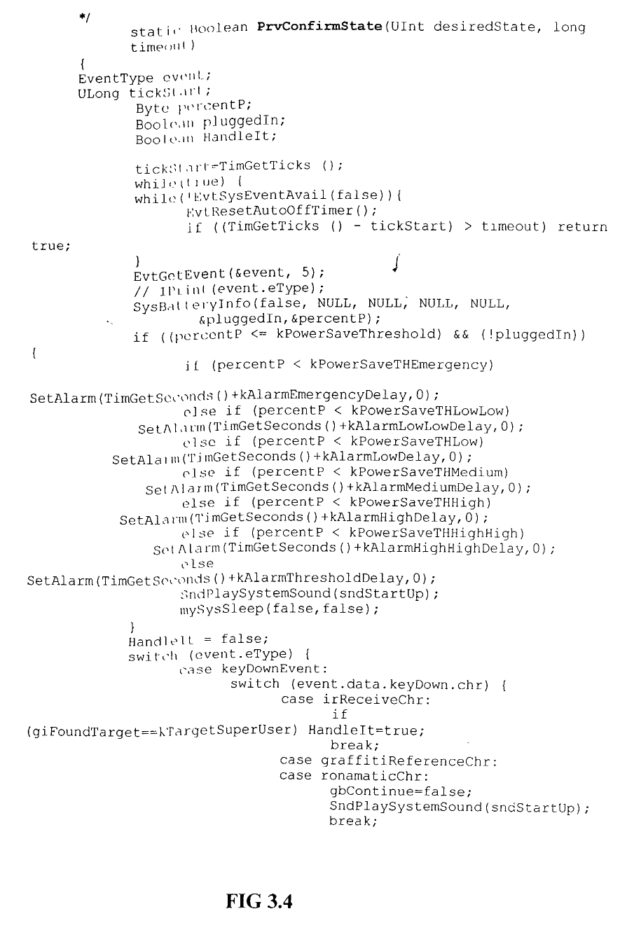

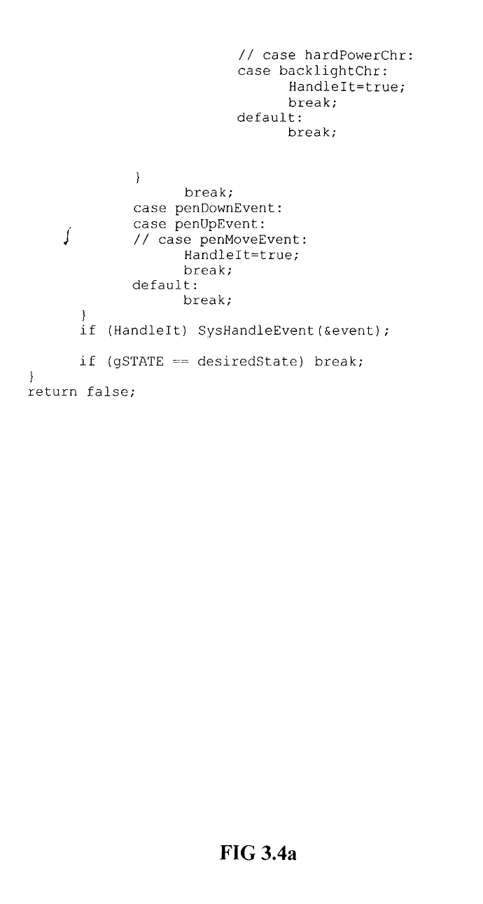

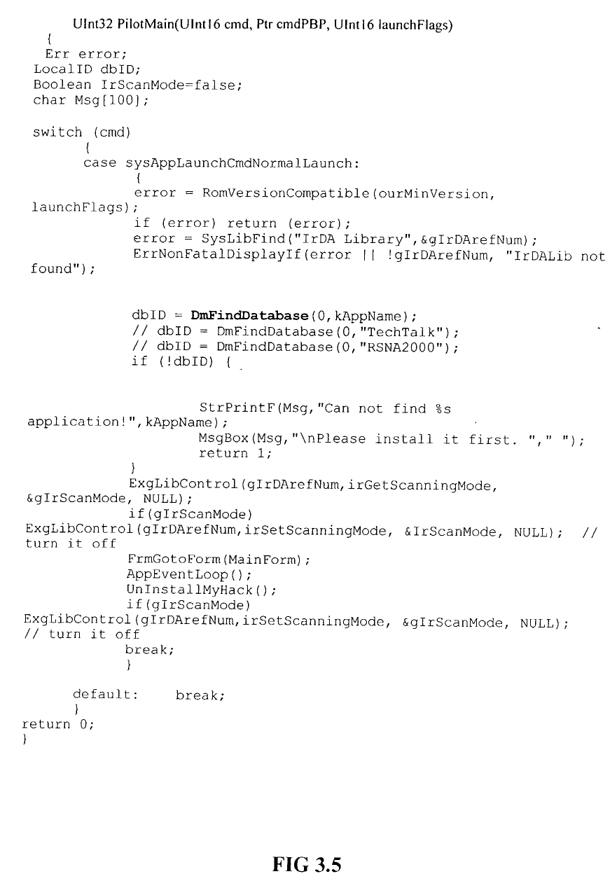

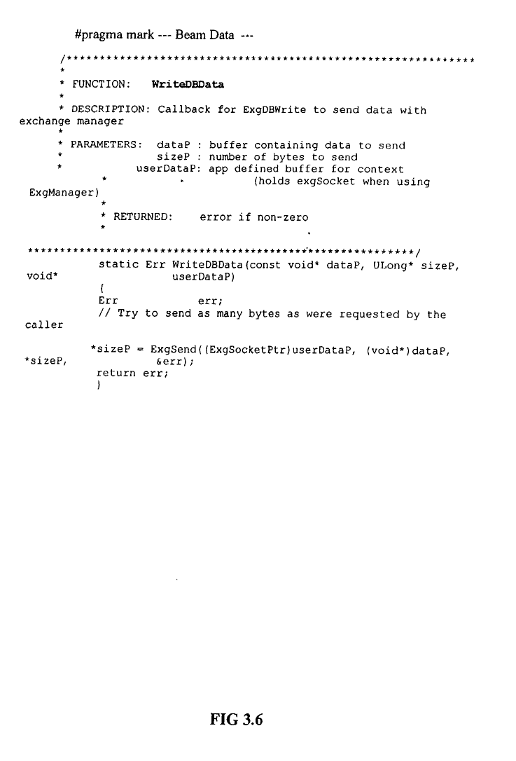

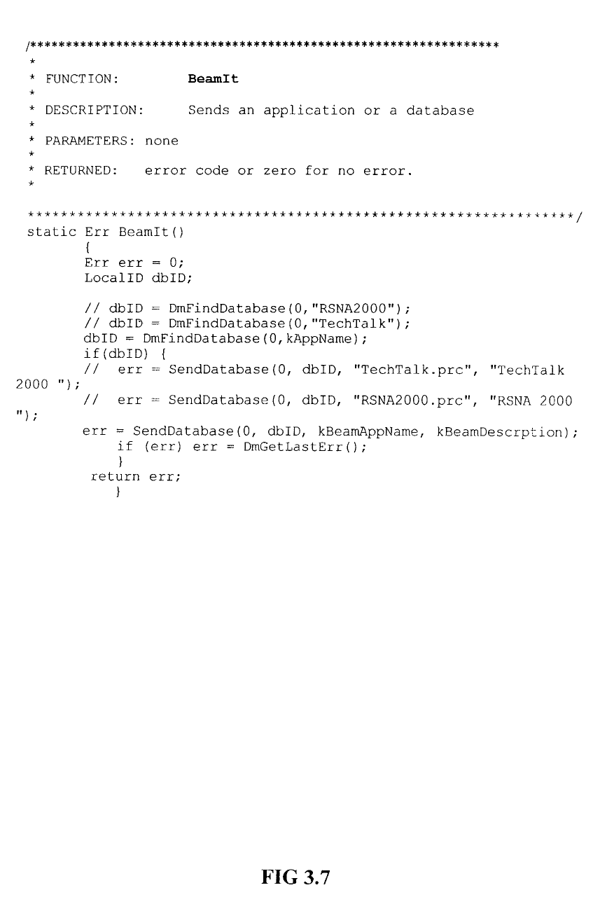

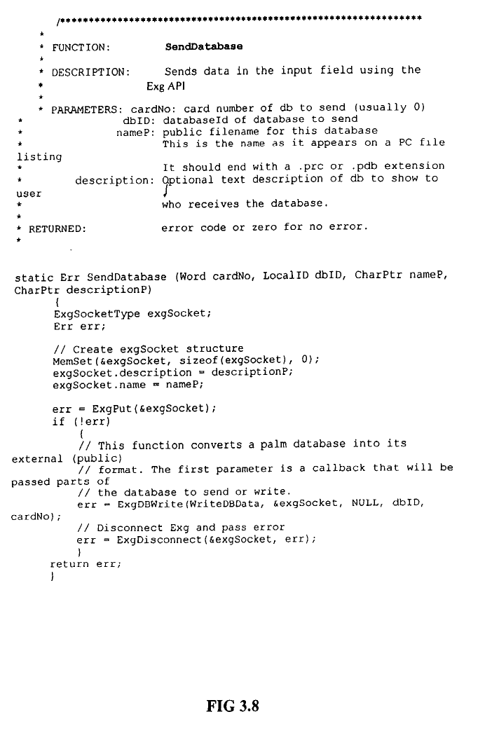

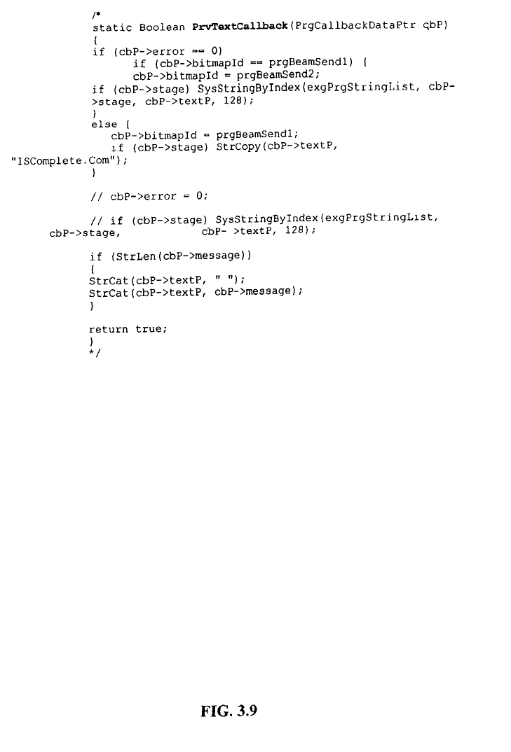

FIG. 3 is a flow-chart depiction illustrating the method steps of the present invention.

The method begins at step 100 (Start) as the user applies power to any two IrOBEX compliant devices, at least one of which (the Host Device) uploads the Continuous Data Beaming software of the present invention as a memory resident program. The software may be written in “C” programming language.

At step 110 the Host Device reads a table of the HotSync schedule to determine if it is time to HotSync to the server; e.g. a database server or Web server. HotSync is a PalmOS® procedure that synchronizes files and/or data objects between a data server and a Palm device. If, at step 120, the current time equals the update time, the system performs a HotSync to the server at step 130, obtains the necessary file or data object and begins again at step 100. If the current time does not equal the time to update, the system goes to step 140.

At step 140 the Host Device begins searching for another IrOBEX compliant device. The search of the IrDA compliant device is accomplished by an Ir Discovery function. The implementing source code for Step 140 and the IrDiscovery function can be found at FIG. 3.1. IrDiscover sends an IrDiscover Request which starts an IrLMP discovery process. By virtue of the Ir Discovery Protocol, the Host Device starts searching for any potential receiver or target IrOBEX compliant device within the IR communication range and that is operative. If there is an IrOBEX compliant device within the range, it will respond with device characteristics back to the requestor. The implementing source code for this function of Step 140 can be found at FIG. 3.2 (kTargetUser and kTarget SuperUser function).

If, at step 150, the Host Unit has found an IrOBEX compliant receiver or target (a Remote Device) through the IR Discovery Protocol, the Host Device checks the availability for connection. The check for availability is accomplished by a ClientCallBack Protocol. The implementing source code for Step 150 and the ClientCallBack Protocol can be found at FIG. 3.3. This call back function handles the indications and confirmation from the protocol stack of FIG. 2.

If the IR Discovery Protocol cannot find an available target, the method returns to step 110 and the Host device checks for scheduled HotSync times.

If, on the other hand, the Remote Device is available, the Discovery Protocol returns a matching “confirm” attribute to the Host Device. The confirm attribute is retrieved by a PrvConfirmState Protocol. The implementing source code for this function of Step 150 can be found at FIG. 3.4 (entitled PrvConfirmState). The PrvConfirmState function simply confirms that the state is the desired state or not. Both the ClientCallBack and PrvConfirmState information is passed back to the IR Discovery Protocol which then checks availability and presence of the “confirm” attribute.

Given that the Remote Device is available and the Discovery Protocol has returned a matching “confirm” attribute to the Host Device, the Host Device checks for a BeamMaster target device at step 160. A BeamMaster target device is a remote device loaded with BeamMaster software, which automatically checks for file or data object updates. The implementing source code for Step 160 and the DmFind Database function can be found at FIG. 3.5. If the target device is a BeamMaster device, the continuous beaming is halted for a maximum of thirty seconds to enable the swapping of files or data objects, at step 170. The implementing source code for Step 170 and the kTargerSuperUSer function can be found at FIG. 3.2. If thirty seconds has not expired or the data transfer is not interrupted at step 180, the files or data objects are transferred and successfully swapped at step 190 and the beaming continues at step 100.

If, at step 160, the target device is not a BeamMaster device or if at step 180, thirty seconds expire or the data transfer is interrupted at step 180, the Host Device tries to initiate a connection to the regular user Remote Device at step 200 by relying on the above-described IrLMP (Infrared Link Management Protocol) which supports walk-up, ad hoc connection between IrOBEX devices. The implementing source code for Step 200 and the IrDiscovery function can be found at FIG. 3.1. This layer of the protocol stack allows software on one device to discover the services available on another device.

If the connection is not successful at step 210, the program returns to step 110 and the Host Device starts to check the HotSync schedule for HotSync times again.

If, on the other hand, connection to the Remote Device has been established by IrLMP at step 210, the data object is recognized and handled intelligently on the receiving side by IrLAP (Infrared Link Access Protocol), which provides a flow-control mechanism between the physical data link layer to the upper layer, communicating with the upper layer in order to manage the communication processes on the IR link between devices. The Continuous Infrared Data Beaming application of the present invention manages the IrLAP protocol with four primary functions: The first is WriteDBData, which is a call back function for ExgDBWrite to send data. The ExgDBWrite function reads a given Palm OS database in its internal format from the local device and writes it out using a function supplied. For example, this function might read a local database and transmit it by a beaming operation using the exchange manager. The implementing source code for Step 210 and the WriteDBData function can be found at FIG. 3.6. The BeamIt function sends an application or database. The implementing source code for Step 210 and the BeamIt function can be found at FIG. 3.7. The SendDatabase function sends data in the input field. The implementing source code for Step 210 and the SendDatabase function can be found at FIG. 3.8. As and 14 Finally, the PrvTextCallback function is a callback function that displays text and icons showing the current progress state. The implementing source code for Step 210 and the PRvTextCallback function can be found at FIG. 3.9. The data object starts transferring through the Infrared ports at step 220. Using the foregoing functions, the selected data object is transferred as a simple IrOBEX transfer. More specifically, the data object is transferred via the IrTTP (Infrared Tiny Transportation Protocol) which provides an independently flow-controlled transport connection, segmentation and reassembly. No packet compression is needed.

The transmission is monitored at step 230 for transmit errors or interruptions, and if the data object has been transferred successfully through the Infrared ports at step 220 the event is recorded in a Record Transmit Log at step 240. The program flow returns to step 110 and the Host Device checks for scheduled HotSync times again.

If the data object is not transferred successfully through the Infrared ports (there was a transmit error or interruption at step 230), program flow returns directly to step 110 and the Host Device checks for scheduled HotSync times again.

The Continuous Data Beaming System is unique in the manner by which it continuously searches for an IrOBEX compliant device, and then beams data objects to these devices. A BeamMaster Remote Device can interrupt this continuous beaming for a brief period to enable the swapping of files or data objects before continuous beaming is reinitiated. No other user Remote Device at the receiving end can interrupt this continuous beaming. The system does not need to be turned off after initial set up and can continue operation throughout the Host Device's life cycle.

An alternative embodiment uses Bluetooth Object Push Profile as the wireless communication protocol. Bluetooth is an open standard for short-range wireless communication between devices over the publicly available radio spectrum, eliminating the need to employ connecting cables and to point to a device. When devices are equipped with the Bluetooth technology, the present invention will continuously beam data through the radio spectrum using the Bluetooth protocol. A microchip, incorporating a radio transceiver, is built into the digital device. The radio operates in a globally available frequency band, ensuring compatibility worldwide. Bluetooth comprises components, including the radio, baseband, link manager, service discovery protocol, transport layer, and interoperability with different communication protocols.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

### INDUSTRIAL APPLICABILITY

Wireless communication is playing an increasingly important role in computer data interchange, particularly for users of mobile computers. This is because it is often necessary to transfer specific data while traveling, when there is no access to conventional telephone lines or other hard-wired means of data transfer. Infrared optical energy, based on the IrOBEX protocol, and Bluetooth wireless technology, based on Bluetooth Object Push Profile, are well-known exemplary media for wireless data transmission. There have been a few known attempts to provide improved wireless transmission software. Unfortunately, these systems require an operator to initiate the transmission software at both the transmitting and receiving ends, and once initiated, to control the process from one of the two terminals. This is inconvenient, given a fast data transfer between a PDA and host computer is usually desired. It would be significantly advantageous to provide a Continuous Data Beaming System that is capable of continuously and automatically beaming data by direct transmission from one source device (or “beaming station”) to another receiver device every time the receiver needs the data.

It would also be advantageous to provide a Continuous Data Beaming System that is capable of being interrupted for a brief period of time to enable files or data objects to be swapped before resuming the continuous data beaming. This function eliminates the need to physically open a locked and secured beaming kiosk and replace the beaming host device to replace a data file or object.

1. A method for continuous, wireless infrared data transmission, comprising the steps of:
searching with a Host Device using an infrared communication protocol to find a Remote Device having an IrOBEX compliant port;
checking for availability of an infrared connection if the Host Device finds a Remote Device having an IrOBEX compliant port;
establishing infrared communication between said Host Device and Remote Device when said infrared connection is available and transferring a file or data object through the respective IrOBEX compliant ports;
recording a successful transfer event in a log file if the file or data object is transferred successfully;
repeating the foregoing steps to effect continuous, wireless infrared data transmission.

2. The method according to claim 1, further comprising the step of checking for scheduled HotSync times and performing a Hot Sync to the server to dynamically update file contents if the time equals the schedule time and continuing beaming existing data object if the times does not equal the schedule time.

3. The method according to claim 1, wherein said step of searching from a Host Device to find an IrOBEX compliant Remote Device is repeated if the Host Device cannot find an IrOBEX compliant Remote Device.

4. The method according to claim 1, wherein said step of checking for availability of an infrared connection is repeated if the Remote Device is not available for connection.

5. The method according to claim 1, wherein said step of transferring a file or data object through the respective compliant ports is repeated if the file or data object is not successful.

6. The method according to claim 1, further comprising the step of checking for a BeamMaster target device, halting the continuous beaming for a short pre-defined period of time to enable the swapping of files or data objects if a BeamMaster target device is detected, swapping the files or data objects, and resuming the continuous beaming.

7. The method according to claim 6, wherein said continuous beaming continues uninterrupted if a BeamMaster target device is not detected.

8. A method for continuous, wireless data transmission, comprising the steps of:
searching from a Host Device to find a Bluetooth wireless technology compliant Remote Device, both of said devices having compliant ports;
checking for availability of a connection if the Host Device finds a Bluetooth compliant Remote Device;
making the connection between Host Device and Remote Device and transferring a file or data object through the respective compliant ports if the Remote Device is available for connection;
recording the transfer in a log file as a successful event if the file or data object is transferred successfully;
whereby continuous, wireless data transmission occurs.

9. An apparatus for performing continuous, wireless infrared data transmission, comprising:
a means for searching from a Host Device to find an IrOBEX compliant Remote Device, both of said devices having compliant ports;
a means for checking for availability of an infrared connection if the Host Device finds an IrOBEX compliant Remote Device;
a means for making the connection between Host Device and Remote Device and transferring a file or data object through the respective compliant ports if the Remote Device is available for connection;
a means for recording the transfer in a log file as a successful event if the file or data object is transferred successfully;
whereby continuous, wireless infrared data transmission occurs.

10. The apparatus according to claim 9, further comprising the means of checking for scheduled HotSync times and performing a Hot Sync to the server to dynamically update file contents if the time equals the schedule time and continuing beaming existing data object if the times does not equal the schedule time.

11. The apparatus according to claim 9, wherein said means of searching from a Host Device to find an IrOBEX compliant Remote Device is repeated if the Host Device cannot find an IrOBEX compliant Remote Device.

12. The apparatus according to claim 9, wherein said means of checking for availability of an infrared connection is repeated if the Remote Device is not available for connection.

13. The apparatus according to claim 9, wherein said means of transferring a file or data object through the respective compliant ports is repeated if the file or data object is not successful.

14. The apparatus according to claim 9, further comprising the means of checking for a BeamMaster target device, halting the continuous beaming for a short pre-defined period of time to enable the swapping of files or data objects if a BeamMaster target device is detected, swapping the files or data objects, and resuming the continuous beaming.

15. The apparatus according to claim 14, wherein said means of continuous beaming continues uninterrupted if a BeamMaster target device is not detected.
